(19) United States
(12) Patent Application Publication
(10) Pub. No.: US 2026/0224015 A1
(43) Pub. Date: Aug. 6, 2026

(54) IMAGE READING DEVICE

(71) Applicant: SEIKO EPSON CORPORATION, Tokyo (JP)

(72) Inventor: Satoshi NAKATA, MATSUMOTO-SHI (JP)

(21) Appl. No.: 19/530,833

(22) Filed: Feb. 5, 2026

(30) Foreign Application Priority Data
Feb. 5, 2025 (JP) 2025-017399

(51) Int. Cl. A46B 5/00; A46B 17/08; H04N 1/00

(52) U.S. Cl. CPC A46B 5/0004; A46B 17/08; H04N 1/00602; H04N 1/00801; A46B 2200/3073

(57) ABSTRACT

An image reading device includes a reading section configured to read a document; a transport section configured to transport the document in a transport direction along a transport path T, and a removal section provided upstream of the reading section in the transport direction, wherein the removal section has a first removal section configured to remove foreign matter on a first surface of the document and a second removal section configured to remove foreign matter on a second surface opposite to the first surface.

The present application is based on, and claims priority from JP Application Serial Number 2025-017399, filed February 5, 2025, the disclosure of which is hereby incorporated by reference herein in its entirety.

### BACKGROUND

### 1. Technical Field

The present disclosure relates to an image reading device.

### 2. Related Art

An image reading device described in JP-A-2010-215321 includes an imaging unit that images a transported medium, a guide plate that constitutes a part of a transport path through which the medium is transported, and a charging member that attracts foreign matter such as paper powder, dust, or the like present in the transport path. The guide plate is formed with a plurality of slits, and the charging member is provided at the upstream side of the imaging unit in a transport direction and is disposed so as to be separated from the transported medium via the slits.

However, in the configuration described in JP-A-2010-215321, although it is possible to attract foreign matter clinging to one surface of the medium, it is not considered to attract foreign matter clinging to the other surface of the medium. Therefore, in an image reading device capable of reading both sides of the medium, there is a risk that foreign matter may cling to the imaging device that images the other side of the medium.

### SUMMARY

An image reading device includes a reading section configured to read a document; a transport section configured to transport the document in a transport direction along a transport path; and a removal section provided upstream of the reading section in the transport direction, wherein the removal section has a first removal section configured to remove foreign matter on a first surface of the document and a second removal section configured to remove foreign matter on a second surface opposite to the first surface.

### BRIEF DESCRIPTION OF THE DRAWINGS

FIG. 1 is an external perspective view of an image reading device.

FIG. 2 is a configuration diagram of the image reading device.

FIG. 3 is a diagram of a state in which an opening and closing unit is removed from the state of FIG. 1.

FIG. 4 is a plan view of the image reading device in which a first removal section is added to a path member.

FIG. 5 is a cross-sectional view of a transport path of the image reading device as viewed from a width direction.

FIG. 6 is a front view illustrating a positional relationship of the first removal section, a feed roller, and an upstream side transport roller pair in the transport path of the image reading device.

FIG. 7 is a front view illustrating a positional relationship of a second removal section, the feed roller, and the upstream side transport roller pair in the transport path of the image reading device.

FIG. 8 is a cross-sectional view of the transport path of the image reading device as viewed from the width direction.

### DESCRIPTION OF EMBODIMENTS

Hereinafter, the present disclosure will be described in detail. Note that an X-Y-Z coordinate system illustrated in each drawing is an orthogonal coordinate system, and a direction in which an arrow is directed is a +X direction, and the opposite direction is a -direction. An X-axis direction is a direction intersecting with a document transport direction, that is, a document width direction and is a width direction of the device. A Y-axis direction is a device depth direction. In the Y-axis direction, a +Y direction is a direction from a device back surface toward a device front surface, and a -Y direction is a direction from the device front surface toward the device back surface. A Z-axis direction is a vertical direction and is a device height direction. In the Z-axis direction, a +Z direction is an upward direction, and a -Z direction is a downward direction.

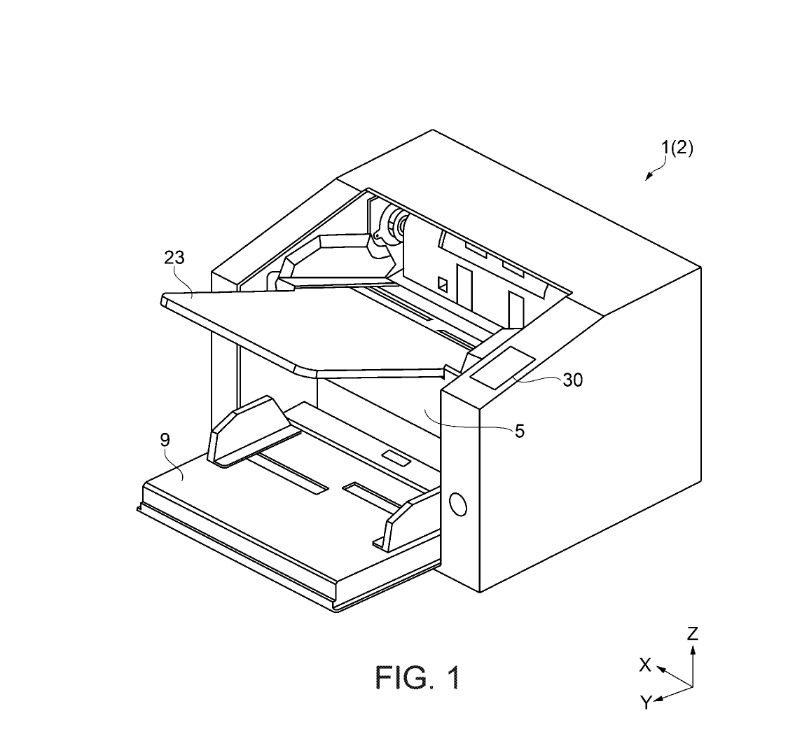

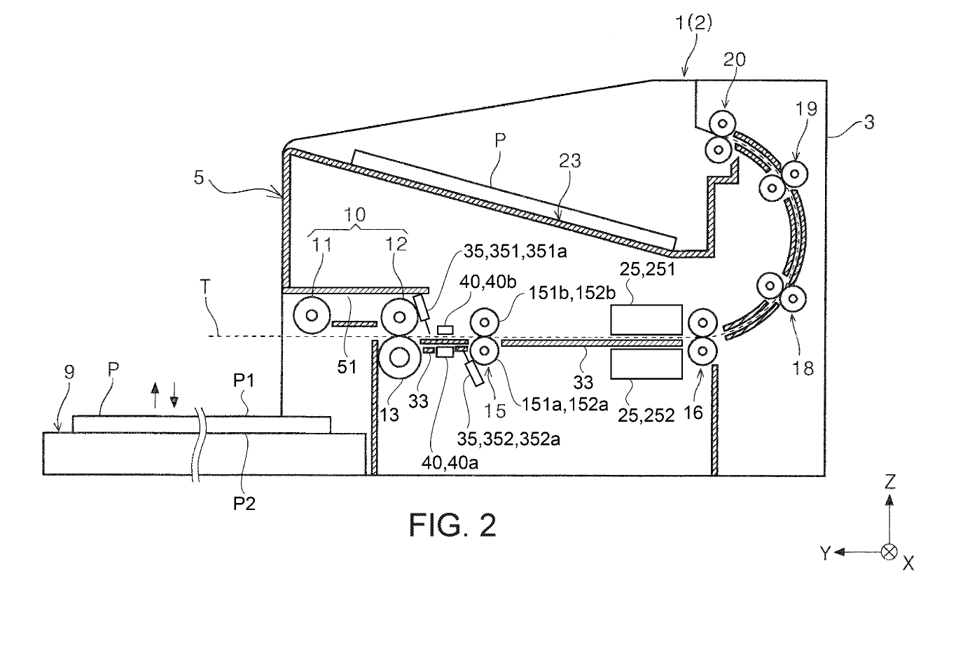

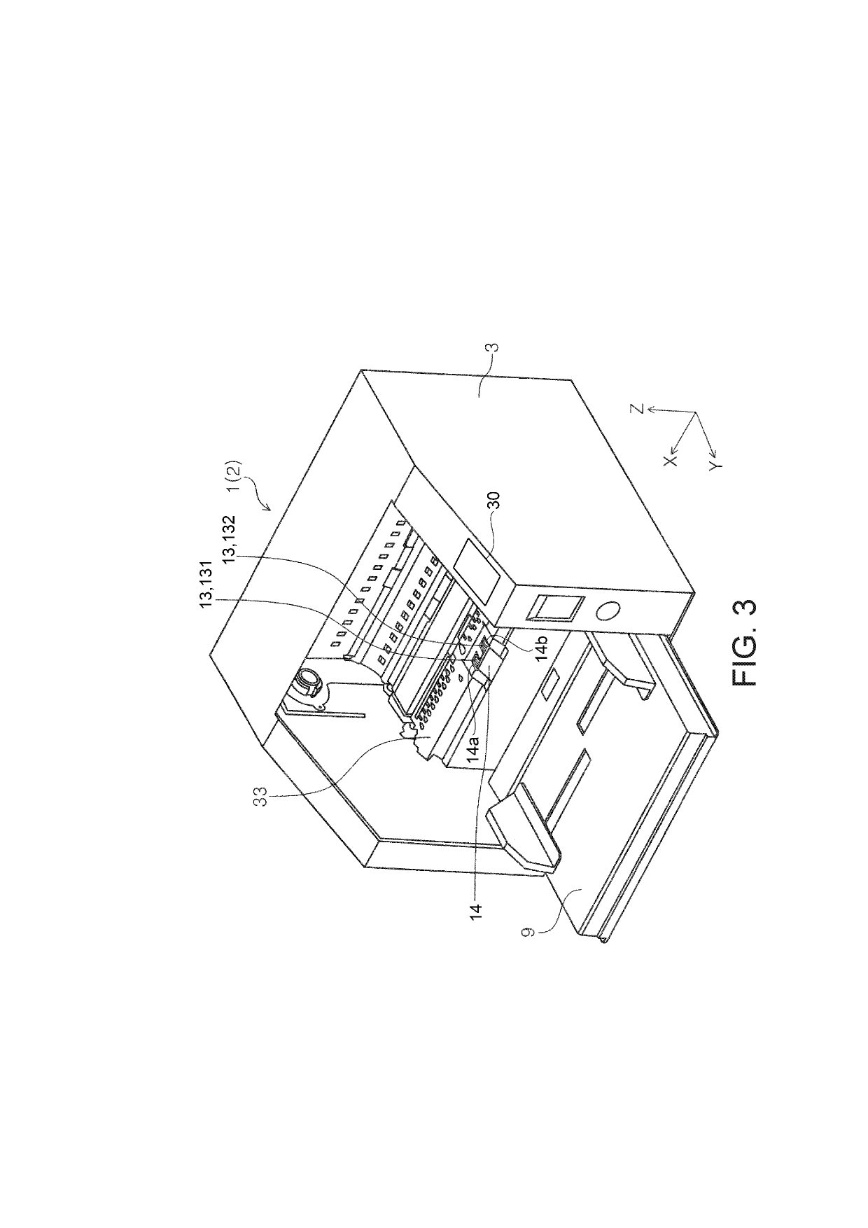

As illustrated in FIG. 1, FIG. 2, and FIG. 3, an image reading device 1 of the present embodiment is a scanner capable of reading an image of a document P, and is a sheet-feed type scanner that reads the image of the document P while transporting the document P. Here, the image of the document P means an image visually recorded on a medium, and is, for example, a character, a figure, a table, a picture, a photograph, or the like. Note that the image reading device 1 may be referred to as a document transport device 2 from the viewpoint of it transporting the document P.

The image reading device 1 includes an opening and closing unit 5, a document support section 9, a reading section 25, an operation display section 30, a path member 33, an upstream side transport roller pair 15, a downstream side transport roller pair 16, an upstream side inversion roller pair 18, a downstream side inversion roller pair 19, a sheet discharge roller pair 20, and a transport path T for transporting the document P. The document support section 9, the path member 33, the downstream side transport roller pair 16, the upstream side inversion roller pair 18, the downstream side inversion roller pair 19, and the sheet discharge roller pair 20 correspond to a transport section that transports the document P in the transport direction along the transport path T.

The transport path T is formed inside a housing 3. In FIG. 2, the transport path T is indicated by a dashed line. In the transport path T, the document P is transported linearly along the -Y direction, is then inverted upward, and is discharged in the +Y direction. Hereinafter, the configuration of the transport path T will be described along the direction in which the document P is transported. Note that in the following description, a direction in which a document is transported may be referred to as "downstream", and a direction opposite to the downstream direction may be referred to as "upstream".

The document support section 9 that supports the document P is provided on the most upstream side of the transport path T. The document support section 9 supports the document P horizontally. Of course, the document support section 9 may support the document P in an inclined posture. The document support section 9 is raised and lowered along the vertical direction by a power source (not illustrated) while maintaining its posture. When the document support section 9 is raised, the document P supported by the document support section 9 can contact a pickup roller 11 (to be described later).

The pickup roller 11 is driven by a motor (not illustrated) and sends the document P supported by the document support section 9 downstream. A feed roller 12 is provided downstream of the pickup roller 11 in the transport path T. The feed roller 12 is a feeding section that is driven by a motor (not illustrated) and that feeds the document P downstream. The pickup roller 11 and the feed roller 12 constitute a feeding section 10 that feeds the document P from the document support section 9.

A separation roller 13 is provided at a position facing the feed roller 12. The separation roller 13 separates the document P by nipping the document P between the separation roller 13 and the feed roller 12. The separation roller 13 is driven by a motor (not illustrated) in a direction in which the document P is returned upstream. A torque limiter (not illustrated) is interposed in a power transmission path between the separation roller 13 and the motor (not illustrated). In a case where only one document P is present between the feed roller 12 and the separation roller 13, the separation roller 13 is driven to rotate in contact with the document P by the action of the torque limiter. In a case where a plurality of documents P are present between the feed roller 12 and the separation roller 13, the separation roller 13 rotates in a direction in which the document P is returned upstream by power of the motor (not illustrated), and by this, double feeding is prevented. Note that a separation pad may be employed instead of the separation roller 13. The pickup roller 11, the feed roller 12, and the separation roller 13 described above are provided at a center position in the document width direction or at positions symmetrical with respect to the center position.

The separation roller 13 is exposed through an opening section 14a and an opening section 14b provided in a cover member 14. The cover member 14 is attachably and detachably provided on the path member 33. The separation roller 13 has a first separation roller 131 and a second separation roller 132 in the width direction.

A first removal section 351 and a second removal section 352 are provided downstream of the feed roller 12 and the separation roller 13. The first removal section 351 and the second removal section 352 constitute a removal section 35 that removes foreign matter Du clinging to the document P. The removal section 35 is provided upstream of the reading section 25 in order to eliminate the influence of foreign matter Du on a scanner sensor, that is, the reading section 25 (to be described later), which reads the image of the document P.

The first removal section 351 is a member that removes foreign matter Du such as paper powder clinging to the first surface P1 of the document P. The second removal section 352 is a member that removes foreign matter Du clinging to the second surface P2 opposite to the first surface P1 of the document P. According to this configuration, since the image reading device 1 has the first removal section 351 and the second removal section 352, it is possible to remove foreign matter from both sides of the document P.

The first removal section 351 has a first brush section 351a. The first brush section 351a is formed of a large number of bristles. The first brush section 351a is a flat surface brush extending in the X-axis direction. The first brush section 351a is held by a subframe 51 so as to be able to contact the first surface P1 of the document P. The first brush section 351a is held by the subframe 51 in a state where it is inclined such that a tip end thereof faces downward and downstream in the transport direction. According to this configuration, since the first removal section 351 has the first brush section 351a capable of removing foreign matter Du clinging to the first surface P1 of the document P during transport, it is possible to remove foreign matter Du by a simple method.

The second removal section 352 has a second brush section 352a. The second brush section 352a is formed of a large number of bristles. The second brush section 352a is a flat surface brush extending in the X-axis direction. The second brush section 352a is held by the path member 33 so as to be able to contact the second surface P2 of the document P. The second brush section 352a is held by the path member 33 in a state where it is inclined such that a tip end thereof faces upward and upstream in the transport direction. According to this configuration, since the second removal section 352 has the second brush section 352a capable of removing foreign matter Du clinging to the second surface P2 of the document P during transport, it is possible to remove foreign matter Du by a simple method. The first brush section 351a and the second brush section 352a are desirably disposed continuously without interruption across the width direction of the path member 33, but may be disposed in a divided form avoiding structures such as sensors.

It is desirable to use a conductive material for the first brush section 351a and the second brush section 352a. In the present embodiment, stainless steel is used, but carbon, iron, or the like other than stainless steel may be used.

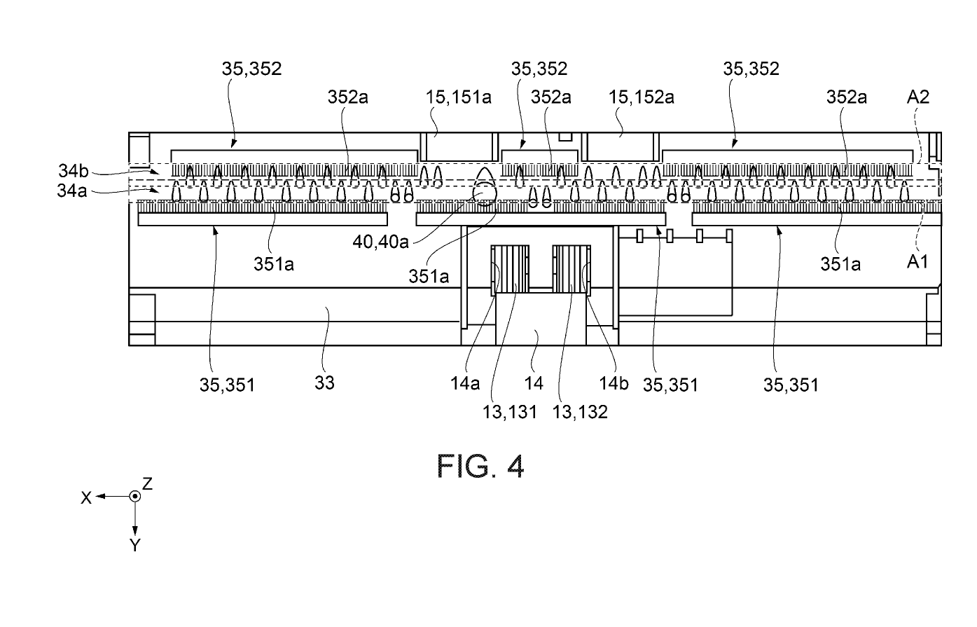

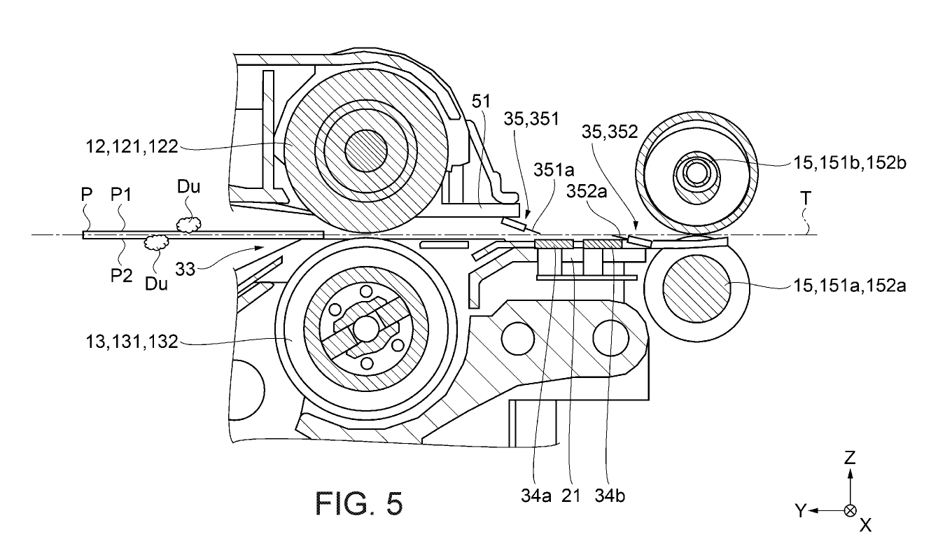

A detection section 40 is disposed on the transport path T interposed between the first removal section 351 and the second removal section 352 along the transport direction. The detection section 40 is composed of an ultrasonic wave transmitting section 40a and an ultrasonic wave receiving section 40b that detect the transport state of the document P by ultrasonic waves. The ultrasonic wave transmitting section 40a is incorporated in the path member 33, and the ultrasonic wave receiving section 40b is held by the subframe 51 and is provided so as to face the transport path T interposed therebetween. The ultrasonic wave transmitting section 40a may be disposed inside a hole section 34 (see FIG. 5) by using an opening of the hole section 34 (see FIG. 4) (to be described later).

The upstream side transport roller pair 15 that functions as a transport roller that transports the document P downstream in the transport direction is provided downstream of the second removal section 352. As illustrated in FIG. 4, the first removal section 351 and the second removal section 352 described above are provided between the feed roller 12 and the upstream side transport roller pair 15 in the transport direction. The upstream side transport roller pair 15 includes a first upstream side transport roller pair 151 disposed along the X-axis direction and a second upstream side transport roller pair 152 provided at an interval from the first upstream side transport roller pair 151. The first upstream side transport roller pair 151 is configured nip using a first upstream side transport lower roller 151a and a first upstream side transport upper roller 151b, and at least one roller is driven by a motor (not illustrated). The second upstream side transport roller pair 152 is configured to be nipped by a second upstream side transport lower roller 152a and a second upstream side transport upper roller 152b, and at least one of the rollers is driven by a motor (not illustrated). Since the first upstream side transport roller pair 151 and the second upstream side transport roller pair 152 transport the document P while nipping the document P, the document P can be transported downstream of the transport path T in a stable state.

The reading section 25, which reads the image of the document P, is provided on the downstream side of the upstream side transport roller pair 15. The reading section 25 includes a first reading section 251 and a second reading section 252. The first reading section 251 and the second reading section 252 are provided so as to face each other with the transport path T interposed therebetween. Of course, the first reading section 251 and the second reading section 252 may be provided at positions shifted in the transport direction. The first reading section 251 is provided above the transport path T and reads the image on the first surface P1 of the document P. The second reading section 252 is provided below the transport path T and reads the image on the second surface P2 of the document P. The first reading section 251 and the second reading section 252 are configured to include a Contact Image Sensor (CIS), for example. According to this configuration, the reading section 25 has the first reading section 251 that reads the first surface P1 of the document P and the second reading section 252 that reads the second surface P2 of the document P, and thus, it is possible to read the images described on the front and back surfaces of the document P. It is desirable that the upstream side transport roller pair 15 that transports the document P while nipping the document P is provided at a position as close as possible to upstream side of the reading section 25. By providing the upstream side transport roller pair 15 at a position as close as possible in the upstream of the reading section 25, the reading section 25 can read the document P in a stable transport state.

The downstream side transport roller pair 16 is provided downstream of the reading section 25. The transport path T extends horizontally in a section from the pickup roller 11 to the downstream side transport roller pair 16. At least one of the upstream side transport roller pair 15 and the downstream side transport roller pair 16 is driven by a motor (not illustrated). The upstream side transport roller pair 15 and the downstream side transport roller pair 16 transport the document P downstream.

Downstream of the downstream side transport roller pair 16, the transport path T curves upward and inverts. In the curved and inverted section, the upstream side inversion roller pair 18, the downstream side inversion roller pair 19, and the sheet discharge roller pair 20 are provided in this order toward the downstream. At least one of the upstream side inversion roller pair 18, the downstream side inversion roller pair 19, and the sheet discharge roller pair 20 is driven by a motor (not illustrated). The upstream side inversion roller pair 18 and the downstream side inversion roller pair 19 transport the document P downstream. The sheet discharge roller pair 20 discharges the document P in the +Y direction. The document P discharged by the sheet discharge roller pair 20 is supported by a discharge sheet receiving section 23. The discharge sheet receiving section 23 supports the document P in an inclined posture. Of course, the discharge sheet receiving section 23 may support the document P in a horizontal posture.

The operation display section 30 displays an operation status of the image reading device 1 and receives an input operation related to image reading on a touch panel.

A series of operations such as the raising and lowering operation of the document support section 9, the rotating operation of each roller, and the image reading operation of the document P by the first reading section 251 and the second reading section 252 is controlled by a control section (not illustrated). The control section includes a CPU, a nonvolatile memory, and the like (not illustrated). Programs, parameters, and the like for performing various types of control are stored in the nonvolatile memory.

The opening and closing unit 5 is attachably and detachably provided in the housing 3. The opening and closing unit 5 forms a part of the transport path T in a closed state.

The opening and closing unit 5 opens a part of the transport path T as illustrated in FIG. 3 in a state of being opened with respect to the housing 3. Note that in FIG. 3, the opening and closing unit 5 in an open state is not illustrated. The opening and closing unit 5 may be attachably and detachably provided to the housing 3. The opening and closing unit 5 includes the subframe 51, and the subframe 51 includes the discharge sheet receiving section 23, the pickup roller 11, the feed roller 12, the first removal section 351, the ultrasonic wave receiving section 40b, the first upstream side transport upper roller 151b, and the second upstream side transport upper roller 152b. The feed roller 12 is configured by a first feed roller 121 and a second feed roller 122. In the subframe 51, the first feed roller 121 and the second feed roller 122 are arranged along the X-axis with a interval therebetween. When the opening and closing unit 5 is opened from the housing 3, the path member 33 is exposed (see FIG. 3).

FIG. 4 is a plan view of the path member 33 with the first removal section 351 added thereto, and illustrates the positional relationship between the path member 33 and the first removal section 351. The path member 33 feeds the document P along the transport path T (see FIG. 2). As illustrated in FIG. 4, the path member 33 includes the separation rollers 13, the cover member 14, the ultrasonic wave transmitting section 40a, a second removal section 352, the first upstream side transport lower roller 151a, and the second upstream side transport lower roller 152a. A plurality of hole sections 34 are provided in the X-Y plane of the path member 33. A box-shaped accommodation section 21 (see FIG. 5) is provided below the path member 33. The accommodation section 21 will be described in detail later.

As a material of the path member 33, a conductive material is preferably used in order to prevent the document P from being charged. Stainless steel is desirably used from the viewpoint of strength and corrosion, but iron, aluminum, reinforced plastic, or the like other than stainless steel may be used.

At the substantial center of the +Y side of the path member 33, the first separation roller 131 and the second separation roller 132 are arranged at intervals along the X-axis, and are opposed to the first feed roller 121 and the second feed roller 122 arranged on the subframe 51 in a manner that allows them to be nipped. The first upstream side transport lower roller 151a and the second upstream side transport lower roller 152a are disposed at the substantial center of the -Y side of the path member 33. Along the transport direction, the second removal section 352 is held between the first separation roller 131 and the second separation roller 132, and between the first upstream side transport lower roller 151a and the second upstream side transport lower roller 152a.

The plurality of hole sections 34 are holes for allowing foreign matter Du to pass from the transport path T toward the accommodation section 21 when accommodating foreign matter Du removed from the document P by the first removal section 351 and the second removal section 352 in the accommodation section 21. The plurality of hole sections 34 are constituted by a plurality of first hole sections 34a arranged along the X-axis direction and a plurality of second hole sections 34a positioned downstream of a plurality of first hole sections 34b and arranged along the X-axis direction.

The accommodation section 21 is a box-shaped member that accommodates foreign matter Du removed from the document P by the first removal section 351 and the second removal section 352. The upper surface of the accommodation section 21 is the path member 33, and all of the plurality of hole sections 34 communicate with the accommodation section 21. The foreign matter Du removed from the document P by the first removal section 351 and the second removal section 352 falls by gravity, passes through the hole sections 34, and is then accommodated in the accommodation section 21. The accommodation section 21 accommodates foreign matter Du removed from the document P, and thus, it is possible to suppress foreign matter Du from being scattered inside and outside the image reading device 1.

The accommodation section 21 may be configured to be attachable to and detachable from the path member 33. By adopting an attachable and detachable structure, it is possible to easily discard the accommodated foreign matter Du. The accommodation section 21 may be divided into a plurality of portions and disposed below the plurality of hole sections 34.

The path member 33 has a first region A1 in which a plurality of first hole sections 34a are provided and a second region A2 in which a plurality of second hole sections 34b are provided. The first region A1 and the second region A2 are substantially rectangular regions, and are positioned in a region sandwiched between the separation roller 13 and the upstream side transport roller pair 15 in the transport direction. The lengths of the first region A1 and the second region A2 in the width direction are equal to the length of the path member 33 in the width direction. The length of the first region A1 in the transport direction is equal to the inside diameter of the first hole section 34a along the transport direction, and the length of the second region A2 in the transport direction is equal to the inside diameter of the second hole section 34b along the transport direction. The second region A2 is provided downstream of the first region A1 in the transport direction. Note that the first region A1 and the second region A2 may be disposed so as to overlap each other in the transport direction. According to this configuration, it is possible to disperse the falling positions of foreign matter Du removed from the document P by the first brush section 351a and foreign matter Du removed by the second brush section 352a.

FIG. 5 is a cross-sectional view of the transport path T of the image reading device 1 as viewed from the -X direction. As illustrated in FIG. 5, the first feed roller 121 and the second feed roller 122 are arranged on the +Y side of the transport path T, and face the first separation roller 131 and the second separation roller 132 in a manner that allows them to be nipped. The upstream side transport roller pair 15 is disposed on the -Y side of the transport path T.

In the transport direction, the first removal section 351 and the second removal section 352 are positioned between the feed roller 12 and the separation roller 13, and the upstream side transport roller pair 15.

The first removal section 351 is held by the subframe 51 in a state inclined such that the tip end of the first brush section 351a faces downward and downstream in the transport direction. The first brush section 351a is held by the subframe 51 such that the tip end of the first brush section 351a, that is, a part of the first brush section 351a, overlaps the first hole sections 34a as viewed from the vertical direction. When the document P is fed along the transport path T, the first brush section 351a contacts with the first surface P1 of the document P and removes foreign matter Du clinging to the first surface P1. The foreign matter Du removed from the first surface P1 by the first brush section 351a falls into the first hole section 34a after the document P passes. According to this configuration, since at least a part of the first brush section 351a overlaps the first hole section 34a as viewed from the vertical direction, foreign matter Du removed from the document P by the first brush section 351a can drop into the first hole section 34a. By this, foreign matter Du can be prevented from scattering inside and outside the image reading device 1.

The second removal section 352 is held by the path member 33 in a state in which it is inclined such that the tip end of the second brush section 352a faces upward and upstream in the transport direction. The second brush section 352a is provided at the path member 33 such that the tip end of the second brush section 352a, that is, a part of the second brush section 352a, overlaps the second hole sections 34b as viewed from the vertical direction. When the document P is fed along the transport path T, the second brush section 352a contacts the second surface P2 of the document P and removes foreign matter Du clinging to the second surface P2. The foreign matter Du removed from the second surface P2 by the second brush section 352a falls into the second hole section 34b after the document P passes. According to this configuration, since at least a part of the second brush section 352a overlaps the second hole section 34b as viewed from the vertical direction, foreign matter Du removed from the document P by the second brush section 352a can drop to the second hole section 34b. By this, foreign matter Du can be prevented from scattering inside and outside the image reading device 1.

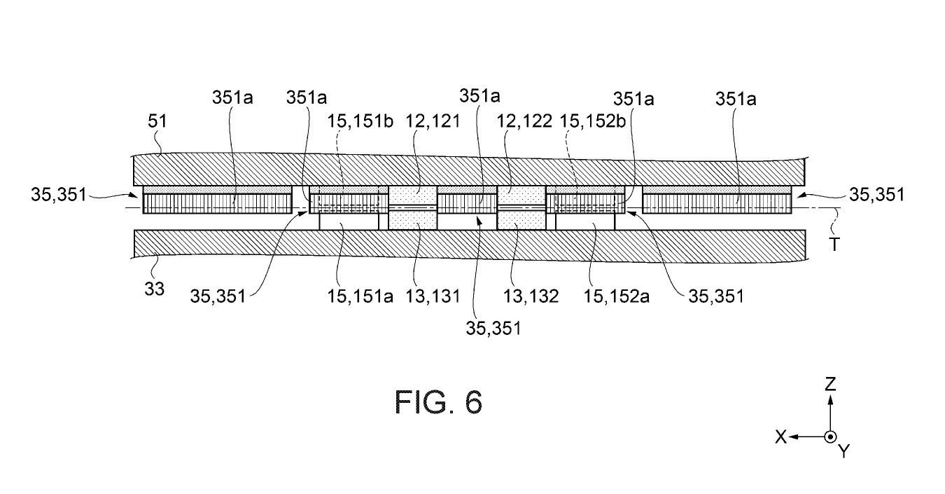

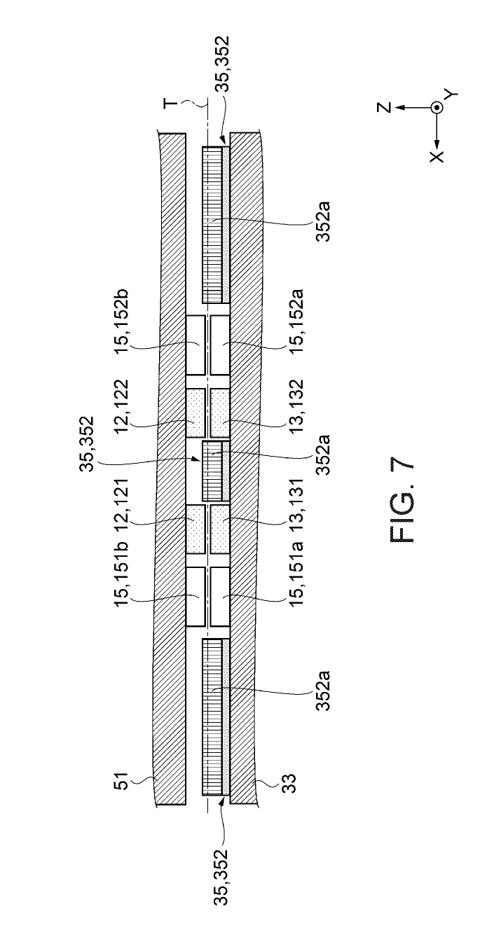

FIG. 6 is a front view illustrating a positional relationship of the first removal section 351, the feed roller 12, and the upstream side transport roller pair 15 in the transport path T of the image reading device 1, and FIG. 7 is a front view illustrating a positional relationship of the second removal section 352, the feed roller 12, and the upstream side transport roller pair 15 in the transport path T of the image reading device 1. As illustrated in FIG. 6 and FIG. 7, at least a part of the first removal section 351 and the second removal section 352 is disposed at a position overlapping at least a part of the upstream side transport roller pair 15 as viewed from the transport direction. At least a part of the first removal section 351 and the second removal section 352 is provided between the first upstream side transport roller pair 151 and the second upstream side transport roller pair 152 in the width direction. According to this configuration, the first removal section 351 and the second removal section 352 are disposed so as to overlap at least a part of the upstream side transport roller pair 15 as viewed from the transport direction, and thus, it is possible to reduce the occurrence of transport failure due to foreign matter Du clinging to the upstream side transport roller pair 15. At least a part of the first removal section 351 and the second removal section 352 is installed between the first upstream side transport roller pair 151 and the second upstream side transport roller pair 152 in the width direction, and thus, it is possible to remove foreign matter in a wider region.

Next, a modification of the above embodiment will be described. Note that in the following description, the same reference symbols are given to the same components as those already described, and redundant descriptions will be omitted.

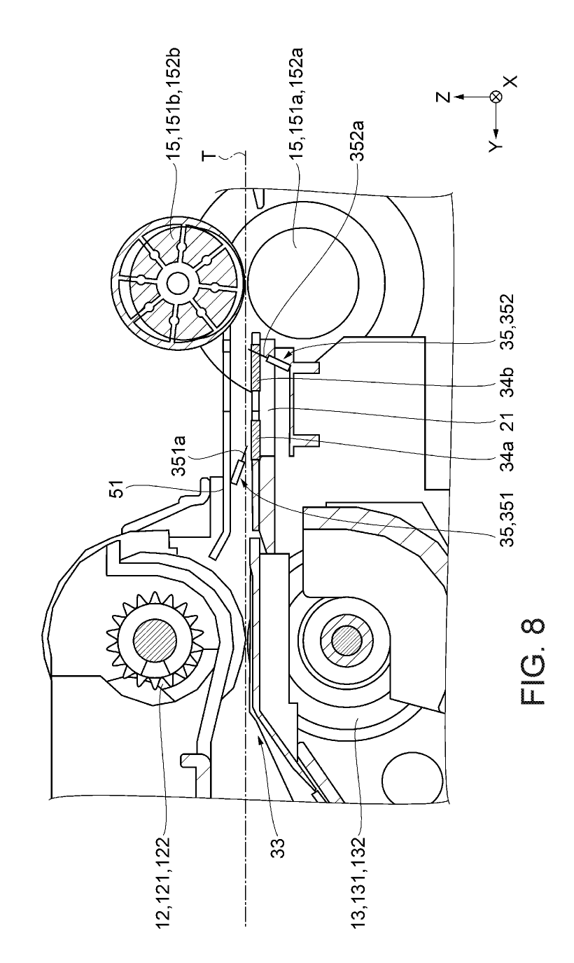

As illustrated in FIG. 8, the second removal section 352 may be provided in the accommodation section 21, and the second brush section 352a may protrude from the second hole section 34b while being inclined such that the tip end thereof faces upward and downstream in the transport direction. By configuring the second brush section 352a to protrude from the second hole section 34b, it is possible to save the mounting space of the second brush section 352a.

The document transport device 2 may be incorporated in a printer and used as a feed mechanism of the medium.

What is claimed is:

1. An image reading device comprising:
a reading section configured to read a document;
a transport section configured to transport the document in a transport direction along a transport path; and
a removal section provided upstream of the reading section in the transport direction, wherein
the removal section has
a first removal section configured to remove foreign matter on a first surface of the document and
a second removal section configured to remove foreign matter on a second surface opposite to the first surface.

2. The image reading device according to claim 1, wherein
the first removal section is a brush configured to contact the first surface.

3. The image reading device according to claim 1, wherein
the second removal section is a brush configured to contact the second surface.

4. The image reading device according to claim 1, further comprising:
an accommodation section configured to accommodate foreign matter removed by the first removal section and the second removal section.

5. The image reading device according to claim 1, wherein
the transport section has a path member constituting the transport path,
the path member is provided with a hole section,
the first removal section is a first brush configured to contact the first surface,
the second removal section is a second brush configured to contact the second surface, and
at least a portion of the first brush and at least a portion of the second brush overlap the hole section as viewed from a vertical direction.

6. The image reading device according to claim 5, wherein
the hole section has
a first hole section and
a second hole section provided downstream of the first hole section in the transport direction,
at least a portion of the first brush overlaps the first hole section as viewed from the vertical direction, and
at least a portion of the second brush overlaps the second hole section as viewed from the vertical direction.

7. The image reading device according to claim 6, wherein
a tip end of the first brush overlaps the first hole section as viewed from the vertical direction and
a tip end of the second brush overlaps the second hole section as viewed from the vertical direction.

8. The image reading device according to claim 6, wherein
the second brush protrudes from the second hole section.

9. The image reading device according to claim 5, further comprising:
an accommodation section configured to accommodate foreign matter removed by the first removal section and the second removal section, wherein
the accommodation section is provided below the path member.

10. The image reading device according to claim 1, further comprising:
a document support section on which the document is placed and
a feeding section configured to feed the document placed on the document support section, wherein
the transport section has a transport roller provided upstream of the reading section in the transport direction and
the removal section is positioned between the feeding section and the transport roller in the transport direction.

11. The image reading device according to claim 10, wherein
at least a portion of the removal section overlaps at least a portion of the transport roller as viewed from the transport direction.

12. The image reading device according to claim 10, wherein
the transport roller includes a first transport roller and a second transport roller provided at an interval from the first transport roller in a width direction, which intersects the transport direction and
at least a portion of the removal section is provided between the first transport roller and the second transport roller in the width direction.

13. The image reading device according to claim 1, wherein
the reading section includes
a first reading section configured to read the first surface and
a second reading section configured to read the second surface.
